(19) United States
(12) Patent Application Publication
(10) Pub. No.: US 2015/0283666 A1
(43) Pub. Date: Oct. 8, 2015

(54) ABRASIVE-GRAIN WIRE TOOL

(71) Applicant: RIKEN CORUNDUM CO., LTD., Saitama (JP)

(72) Inventors: Hidetoshi Nakajima, Konosu City (JP); Katsunori Shioyama, Konosu City (JP); Akihiro Takaiwa, Konosu City (JP); Kazuaki Tanaka, Konosu City (JP); Satoru Suzuki, Konosu City (JP); Takahiro Ushioda, Konosu City (JP)

(73) Assignee: RIKEN CORUNDUM CO., LTD., Konosu City, Saitama (JP)

(21) Appl. No.: 14/437,988

(22) PCT Filed: Oct. 24, 2013
(86) PCT No.: PCT/JP2013/078834

§ 371 Date: Apr. 23, 2015

(30) Foreign Application Priority Data
Oct. 26, 2012 (JP) 2012-237282

(51) Int. Cl. B24B 27/06; B28D 5/04

(52) U.S. Cl. CPC B24B 27/0633; B28D 5/045

(57) ABSTRACT

The wire tool with abrasive grains comprises a wire, and abrasive grains fixed by electrification hole plating in electrification holes, which are provided at multiple spots on the outer circumferential surface of the wire. The cylindrical electrification holes are disposed on a helical curve separated from each other by a uniform gap and the gap is larger than ⅓ of the radius (R) of the electrification holes.

### TECHNICAL FIELD

The present invention relates to an abrasive-grain wire tool, and particularly relates to an abrasive-grain wire tool in which abrasive grains are fixed by plating to the outer periphery of a wire.

### BACKGROUND ART

Conventionally, a wafer for solar power generation, semiconductor devices, LED elements, or substrates for growing LED elements has been cut (or sliced) by specialized cutters, such as a multi-wire saw capable of producing a number of wafers at the same time. Such specialized cutters often includes an abrasive-grain wire tool having abrasive grains, such as diamond grains, fixed to the outer periphery of the abrasive-grain wire tool. In the abrasive-grain wire tool, the abrasive grains (e.g., diamond grains) are fixed by the following methods having advantages and disadvantages described below.

(a) A method of fixing abrasive grains with resin involves applying a mixture of the resin and the abrasive grains to the wire. Due to low strength of holding the abrasive grains, the efficiency of cutting a wafer or the like is low and the tool life is short. Specialized cutters need to be more equipped to ensure a certain amount of cutting (amount of production). A large number of wires are consumed.

(b) A method of fixing abrasive grains by brazing involves applying brazing filler metal to the outer periphery of the wire in advance, heating the applied brazing filler metal to melt it, and fixing abrasive grains to the melted brazing filler metal. Since the wire is heated, the quality of the wire is degraded (i.e., the wire is heated to a temperature which affects the quality). Additionally, a cut surface of a work material (wafer etc.) is said to be significantly damaged by the processing.

(c) A method of fixing abrasive grains by plating involves preparing a plating solution in which abrasive grains are suspended, and immersing the wire in the plating solution to allow deposition of plating on the outer periphery of the wire and codeposition of the abrasive grains. This requires a high manufacturing cost, because of low efficiency in producing the abrasive-grain wire tool. Additionally, a cut surface of a work material (wafer etc.) is said to be significantly damaged by the processing.

In all the methods described above, abrasive grains are automatically fixed to, and randomly (irregularly) distributed over, the outer periphery of the wire. Additionally, unnecessary abrasive grains which do not contribute to or may even interfere with the cutting operation are also fixed. This increases the price of the abrasive-grain wire tool, degrades the cut quality (i.e., causes roughness or deformation of the cut surface) of the work material (wafer etc.), increases variation in quality, and interferes with high-efficiency processing.

A wire with fixed abrasive grains is disclosed, in which many abrasive grains are primary-fixed by a helical adhesive layer to the outer periphery of a single conductive wire and secondary-fixed by an electrodeposited metal plating layer (see, e.g., Patent Literature 1).

### CITATION LIST

### Patent Literature

Patent Literature 1: Japanese Unexamined Patent Application Publication No. 2011-230258 (pages 5 to 7, FIG. 1)

### SUMMARY OF INVENTION

### Technical Problem

The wire with fixed abrasive grains disclosed in Patent Literature 1 has the following problems, because the abrasive grains are primary-fixed by the helical adhesive layer and secondary-fixed by the metal plating layer.

(a) The range of metal plating is narrowed by the adhesive layer, and the abrasive grains may not be firmly fixed.

(b) Since the fixed abrasive grains are in contact with each other, chips produced by a given fixed abrasive grain may be stuck between fixed abrasive grains, or may be pressed against a work material (wafer etc.) by an adjacent abrasive grain. This may lead to degradation of cutting efficiency and cut quality (i.e., cause roughness or deformation of the cut surface).

(c) Since grains are fixed continuously in the form of a helical curve, the wire may be broken by being twisted during cutting.

(d) In particular, when cutting is performed by reciprocation of the wire, the discharge direction of chips and coolant (cutting fluid) is reversed. This may interfere with the discharge of the chips and coolant, or may increase the risk of wire breakage because the wire is repeatedly twisted while its twisting direction is being reversed.

The present invention copes with the problems described above. An object of the present invention is to provide an abrasive-grain wire tool that facilitates discharge of chips and coolant, allows high-efficiency cutting, and helps produce high-quality wafers.

### Solution to Problem

(1) An abrasive-grain wire tool of the present invention includes a wire and abrasive grains fixed by conducting hole plating in conducting holes at multiple points in an insulating layer covering an outer periphery of the wire. The conducting holes are spaced apart from each other on the same line, with gaps therebetween.

(2) In the abrasive-grain wire tool described in (1), the insulating layer is removed.

(3) In the abrasive-grain wire tool described in (2), surfaces of the abrasive grains, surfaces of the conducting hole plating, and the outer periphery of the wire except the surfaces of the abrasive grains and the surfaces of the conducting hole plating are covered with full-surface plating.

(4) An abrasive-grain wire tool of the present invention includes a wire having an outer periphery covered with base plating, and abrasive grains fixed by conducting hole plating in conducting holes at multiple points in an insulating layer covering a surface of the base plating on the wire. The conducting holes are spaced apart from each other on the same line, with gaps therebetween.

(5) In the abrasive-grain wire tool described in (4), the insulating layer is removed.

(6) In the abrasive-grain wire tool described in (5), surfaces of the abrasive grains, surfaces of the conducting hole plating, and the surface of the base plating on the wire except the surfaces of the abrasive grains and the surfaces of the conducting hole plating are covered with full-surface plating.

(7) In the abrasive-grain wire tool described in (3) or (6), the full-surface plating is composite plating mixed with one or more of the following types: fine abrasive grain, fine cerium oxide particle, and fine zircon sand.

(8) In the abrasive-grain wire tool described in any one of (1) to (7), the gaps each between every two adjacent conducting holes are equal.

(9) In the abrasive-grain wire tool described in any one of (1) to (8), the conducting holes have a circular shape, and the gaps between the conducting holes are each greater than one-third of a radius of the circular shape.

(10) In the abrasive-grain wire tool described in any one of (1) to (9), the conducting holes are arranged on one or more helical curves in the outer periphery of the wire.

(11) In the abrasive-grain wire tool described in any one of (1) to (10), the conducting holes are arranged on straight lines parallel to a longitudinal direction of the wire, and equiangularly spaced apart in a circumferential direction of the wire.

(12) In the abrasive-grain wire tool described in any one of (1) to (11), one abrasive grain or an aggregate of abrasive grains is fixed in each of the conducting holes. A diameter of the one abrasive grain or a diameter of the aggregate is less than or equal to a diameter of the conducting hole.

(13) In the abrasive-grain wire tool described in any one of (1) to (12), before the abrasive grains are fixed in the conducting holes, outer peripheries of the abrasive grains are pretreated such that surfaces of the abrasive grains are each turned into a conductive material.

### Advantageous Effects of Invention

An abrasive-grain wire tool of the present invention configured as described above has the following effects.

(i) The conducting holes are spaced apart from each other on the same line, with gaps therebetween. This means that the abrasive grains fixed in the conducting holes are also spaced apart from each other, with gaps therebetween. Therefore, chips and coolant (cutting fluid) produced by a given abrasive grain are not stuck between the given abrasive grain and its adjacent abrasive grain, and are discharged through the gap between the given abrasive grain and its adjacent abrasive grain. This reduces dogging, enhances the effect (cooling effect etc.) of the coolant, maintains the height of cutting edges, and reduces degradation of sharpness. Also, the chips produced by the given abrasive grain can be prevented from being pressed against a work material (wafer etc.) by its adjacent abrasive grain.

During cutting, chips and coolant can pass near the abrasive grains as described above. For example, abrasive grains do not aggregate to form a wall that guides the chips and coolant to be discharged in a specific direction. Thus, since the discharge of chips and coolant is not limited to a specific direction (i.e., chips and coolant are discharged in random directions), the risk of wire breakage caused by twisting of the wire can be reduced. In particular, when cutting is performed by reciprocation of the wire, the discharge of chips and coolant is facilitated because they are discharged in random directions. Also, since the wire is not repeatedly alternately twisted, the risk of wire breakage can be reduced. Thus, cutting efficiency and cut quality are improved (roughness and deformation of the cut surface can be reduced).

Since abrasive grains larger than the conducting holes are not fixed in the conducting holes, abnormal scratches on the cut surface caused by coarse grains can be reduced. This also contributes to improved cut surface quality.

Additionally, since the abrasive grains are fixed in conducting holes having a predetermined area (volume), it is possible to prevent fixation of an unnecessarily large number of abrasive grains. Therefore, the use of raw materials (abrasive grains) and the cost of manufacture can be reduced.

(ii) After the abrasive grains are fixed in the conducting holes by plating codeposition, the insulating layer is removed. Thus, the conducting holes in the insulating layer disappear and the conducting hole plating and the abrasive grains partly exist in locations where there were the conducting holes. Thus, since the abrasive grains can form cutting edges with increased protrusions, it is possible to provide sharpness sufficient for cutting.

(iii) Surfaces of the abrasive grains, surfaces of the conducting hole plating, and the outer periphery of the wire are covered with full-surface plating. Thus, the abrasive grains can be firmly fixed, and wear of the outer periphery of the wire can be reduced. Since the tool life can thus be increased, the cost of the cutting operation can be reduced.

(iv) The outer periphery of the wire is covered with base plating, to which the abrasive grains are fixed by the conducting hole plating. It is thus possible not only to achieve the effect (i) described above, but also to firmly fix the abrasive grains and reduce the risk of falling of the abrasive grains during use (during cutting of a wafer etc.).

(v) After the abrasive grains are fixed in the conducting holes by plating codeposition, the insulating layer is removed. Thus, the conducting holes in the insulating layer disappear and the conducting hole plating and the abrasive grains partly exist in locations where there were the conducting holes. Thus, since the abrasive grains can form cutting edges with increased protrusions, it is possible to provide sharpness sufficient for cutting.

(vi) Surfaces of the abrasive grains, surfaces of the conducting hole plating, and the surface of the base plating covering the outer periphery of the wire are covered with full-surface plating. Thus, the abrasive grains can be further firmly fixed, and wear of the outer periphery of the wire can be further reduced. It is thus possible to further increase the tool life and reduce the cost of the cutting operation.

(vii) The full-surface plating is composite plating mixed with one or more of the following types: fine abrasive grain, fine cerium oxide particle, and fine zircon sand. Thus, the full-surface plating has the effect of improving wear resistance, resistance to adhesion of chips, or lapping characteristics, in cooperation with the abrasive grains. Since the fine abrasive grains or the like codeposited with plating contribute to the cutting of a wafer or the like, it is possible to further improve cutting efficiency and cut quality (i.e., further reduce roughness and deformation of the cut surface).

(viii) The conducting holes are arranged on a predetermined line (helical curve or straight line) such that the gaps between adjacent conducting holes are equal. Therefore, the abrasive grains arranged with substantially equal gaps therebetween are fixed to the periphery, in a balanced manner, at a uniform density over a long distance. This allows a multi-wire saw to simultaneously cut several hundred or thousand thin wafers, each having a thickness of several hundred micrometers (μm), with good linearity, and improves the quality of cut wafers (i.e., reduces roughness of the cut surface (or stabilizes the profile irregularity) and reduces deformation of the cut surface). Providing the gaps between the abrasive grains facilities discharge of chips and coolant, reduces clogging, and enhances the effect (cooling effect etc.) of the coolant. It is thus possible to further improve the cutting efficiency and the quality of cut wafers.

When the conducting holes are evenly spaced in the circumferential direction and arranged with equal gaps therebetween in the longitudinal direction, gaps between the conducting holes in the circumferential direction may be either the same as or different from those between the conducting holes in the longitudinal direction (i.e., the conducting holes may or may not be arranged in a grid pattern in a developed plan view). When the conducting holes are arranged on multiple helical curves, a gap between one of conducting holes evenly spaced on one helical curve and one of conducting holes evenly spaced on another helical curve opposite the one helical curve may not necessarily need to be the same as the gaps between the conducting holes on the one helical curve or the gaps between the conducting holes on the other helical curve.

(ix) Since the conducting holes have a circular shape, the conducting holes can be formed easily. Since the gaps between the conducting holes are each greater than one-third of the radius of the conducting holes, substantial gaps are created between the conducting holes. Since the abrasive grains do not overlap each other, discharge of chips and coolant is ensured. Even if some abrasive grains fall off the outer periphery of the wire, they do not adhere to adjacent abrasive grains.

Therefore, since the depth of cut and the cutting load are stabilized, the cutting efficiency and cut quality can be further improved (roughness and deformation of the cut surface can be further reduced).

(x) The conducting holes are arranged on one or more helical curves, arranged on straight lines parallel to the longitudinal direction of the wire, or arranged in the circumferential direction perpendicular to the longitudinal direction of the wire. This facilitates formation of the conducting holes.

When the conducting holes are evenly spaced in the circumferential direction and arranged with equal gaps therebetween in the longitudinal direction, gaps between the conducting holes in the circumferential direction may be either the same as or different from those between the conducting holes in the longitudinal direction.

(xi) One abrasive grain or an aggregate of abrasive grains is fixed in each of the conducting holes. That is, relatively large abrasive grains are independently fixed, relatively small abrasive grains are fixed in groups each containing several abrasive grains (e.g., about two to five abrasive grains), and fine abrasive grains are fixed in dusters each containing many abrasive grains. Thus, the range of selection of abrasive grains to be used can be widened.

Since cutting edges are evenly spaced, a good level of sharpness can be provided even when fine abrasive grains are used. Therefore, the diameter of the wire and the cutting allowance can be reduced, and the material yield in cutting a work material (wafer etc.) can be increased. It is thus possible to reduce the cost of cutting operation in manufacturing the products (wafers etc.).

Using dusters of many fine abrasive grains can reduce processing damage (e.g., roughness or modification of the cut surface) during cutting. Therefore, the surface quality of products (e.g., wafers) after cutting can be improved.

A diameter of the one abrasive grain or a diameter of the aggregate is less than or equal to a diameter of the conducting holes. Since gaps are formed between abrasive grains or between aggregates, the effect (i) described above can be achieved.

(xii) Before the abrasive grains are fixed in the conducting holes, outer peripheries of the abrasive grains are pretreated such that the surfaces of the abrasive grains are each turned into a conductive material. This tightens the bonding between the conductive material on the surface of each abrasive grain and the conducting hole plating, and allows the abrasive grains to be more firmly fixed. Even when untreated abrasive grains are used, they can be fixed in the conducting holes.

### BRIEF DESCRIPTION OF DRAWINGS

FIG. 1 provides a lateral view and a developed plan view illustrating an abrasive-grain wire tool according to Embodiment 1 of the present invention.

FIG. 2 provides a front cross-sectional view and an enlarged front cross-sectional view of the abrasive-grain wire tool illustrated in FIG. 1.

FIG. 3 is a developed plan view for explaining a variation of the arrangement of conducting holes of the abrasive-grain wire tool illustrated in FIG. 1 (conducting holes are regularly arranged on multiple helical curves).

FIG. 4 is a developed plan view for explaining another variation of the arrangement of conducting holes of the abrasive-grain wire tool illustrated in FIG. 1 (conducting holes are regularly arranged on straight lines parallel to the axial direction).

FIG. 5 provides a developed plan view and a cross-sectional view of the developed plan view for explaining a variation of the fixed state of abrasive grains of the abrasive-grain wire tool illustrated in FIG. 1 (single grains).

FIG. 6 provides a developed plan view and a cross-sectional view of the developed plan view for explaining another variation of the fixed state of abrasive grains of the abrasive-grain wire tool illustrated in FIG. 1 (combined grains).

FIG. 7 provides a developed plan view and a cross-sectional view of the developed plan view for explaining another variation of the fixed state of abrasive grains of the abrasive-grain wire tool illustrated in FIG. 1 (combined fine grains).

FIG. 8 provides a developed plan view and a cross-sectional view of the developed plan view for explaining another variation of the fixed state of abrasive grains of the abrasive-grain wire tool illustrated in FIG. 1 (combined fine grains).

FIG. 9 is an enlarged front cross-sectional view illustrating an abrasive-grain wire tool according to Embodiment 2 of the present invention.

FIG. 10 is an enlarged front cross-sectional view illustrating an abrasive-grain wire tool according to Embodiment 3 of the present invention.

FIG. 11 is an enlarged front cross-sectional view illustrating an abrasive-grain wire tool according to Embodiment 4 of the present invention.

FIG. 12 is an enlarged front cross-sectional view illustrating an abrasive-grain wire tool according to Embodiment 5 of the present invention.

### DESCRIPTION OF EMBODIMENTS

### Embodiment 1

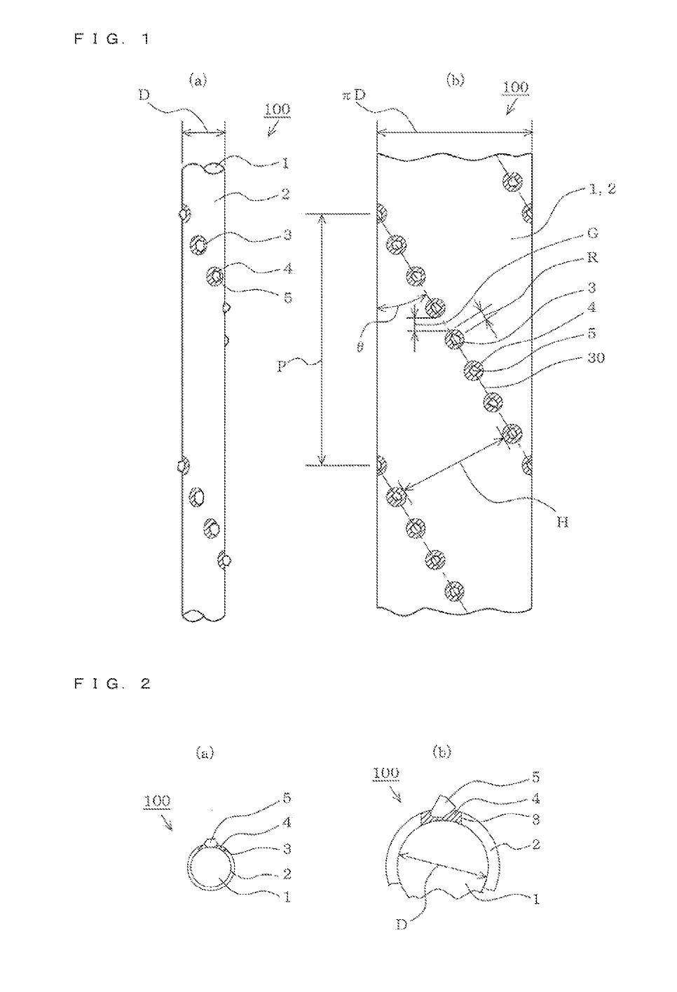

FIGS. 1 and 2 illustrate an abrasive-grain wire tool according to Embodiment 1 of the present invention. FIG. 1(a) is a lateral view, FIG. 1(b) is a developed plan view, FIG. 2(a) is a front cross-sectional view, and FIG. 2(b) is an enlarged front cross-sectional view. These drawings are schematic, and Embodiment 1 is not limited to the illustrated configuration. Note that relative sizes (thicknesses) are exaggerated in the drawings.

Referring to FIGS. 1 and 2, an abrasive-grain wire tool (hereinafter referred to as “wire tool”) 100 has a wire 1, an insulating layer 2 covering the outer periphery of the wire 1, conducting holes 3 formed by removing parts of the insulating layer 2 to expose the outer periphery of the wire 1, and abrasive grains 5 fixed by conducting hole plating 4 in the conducting holes 3. As described below, the insulating layer 2 may be removed after the abrasive grains 5 are fixed. After the removal of the insulating layer 2, the remaining components may be entirely covered with “full plating”.

(Wire)

The wire 1 is a conductive linear element. The wire 1 allows plating codeposition and is strong enough to withstand a tensile force acting on the wire 1 during cutting of a wafer or the like. The outside diameter (D) of the wire 1 is determined in accordance with the environment and conditions of the cutting operation, such as a cutter to be used, a tensile force acting on the wire, and the thickness and the number of wafers. As described below, the size and the arrangement of the conducting holes 3 and the size of the abrasive grains 5 are appropriately selected also in accordance with the environment and conditions of the cutting operation. The material of the wire 1 is not particularly limited. For example, a high-carbon piano wire, or a high-strength or high-corrosion resistance stainless steel wire or maraging steel wire, is used as the wire 1.

(Insulating Layer)

The insulating layer 2 is for forming the conducting holes 3. The insulating layer 2 is provided to prevent a plating solution (mixed with the abrasive grains 5 for plating codeposition) from coming into contact with the area outside the conducting holes 3. The material (synthetic resin etc.) forming the insulating layer 2 is not particularly limited, but is preferably one that facilitates partial removal for forming the conducting holes 3 and is resistant to peeling for plating codeposition (for forming the conducting hole plating 4).

The thickness of the insulating layer 2 is selected in accordance with the size of the abrasive grains 5. The insulating layer 2 may be removed after the abrasive grains 5 are fixed. By removing the insulating layer 2, the abrasive grains 5 can form cutting edges with increased protrusions and thus can provide sharpness sufficient for cutting.

(Conducting Holes)

The conducting holes 3 are formed by removing parts of the insulating layer 2 to expose the outer periphery of the wire 1. The conducting holes 3 each have a cylindrical shape with a predetermined diameter. The conducting holes 3 are evenly spaced on a single helical curve (drawn as straight lines in the developed view) 30 in the outer periphery of the wire 1. A gap (in the longitudinal direction, to be exact) G between conducting holes 3 in dose proximity is greater than one third of the radius R of the conducting holes 3 (G>R/3).

The way of forming the conducting holes 3 is not particularly limited. For example, the conducting holes 3 may be formed by thermally melting and removing parts of the insulating layer 2 with laser beams. Alternatively, the conducting holes 3 may be bored by mechanically removing parts of the insulating layer 2.

The conducting holes 3 have a cylindrical shape to facilitate formation thereof, but the shape of the conducting holes 3 in the present invention is not limited to a cylindrical shape. When the conducting holes 3 are not cylindrical in shape, an equivalent cylinder of substantially the same volume (or cross-sectional area) is determined. Then, the gap between conducting holes 3 in dose proximity is made greater than one third of the radius R of the equivalent cylinder.

A pitch P of the helical curve 30 is not particularly limited (the pitch P is the axial distance moved in a single turn, and the pitch P and the “inclination θ” shown in the developed view have the relationship represented by “tan(θ)=πD/P”). When the pitch P is small (i.e., the inclination θ is large), the conducting holes 3 in the first turn of the helical curve 30 are dose to the conducting holes 3 in the second turn of the helical curve 30. The gap (H) between conducting holes 3 closest to each other is greater than one third of the radius R of the conducting holes 3 (H>R/3).

The conducting holes 3 are not limited to those arranged on a single helical curve. The conducting holes 3 may be evenly spaced on multiple helical curves. Alternatively, at multiple positions evenly spaced in the circumferential direction of the wire 1, the conducting holes 3 may be evenly spaced on lines parallel to the axial direction (this will be described in detail below).

(Conducting Hole Plating)

The conducting hole plating 4 is formed in the conducting holes 3 during plating codeposition of the plating solution mixed with the abrasive grains 5 (i.e., when the abrasive grains 5 mixed with the plating solution are deposited during electrodeposition plating). The abrasive grains 5 are firmly fixed to the surface of the wire 1 by the conducting hole plating 4.

The electrodeposition plating is not particularly limited. Using nickel (Ni) plating or nickel-phosphorus (Ni—P) alloy plating can improve wear resistance and increase the force of holding the abrasive grains 5 because of high plating hardness.

(Abrasive Grains)

The abrasive grains 5 are hard grains, such as grains of silicon carbide, aluminum oxide, boron carbide, diamond, or silicon nitride. That is, the abrasive grains 5 are grains of an element in Group 3, 4, or 5 of the periodic table, such as boron, silicon, aluminum, titanium, or vanadium, or its carbide, nitride, or oxide.

Although one abrasive grain 5 is fixed in each conducting hole 3 in the foregoing description (in this case, the outside diameter of the abrasive grain 5 is smaller than the inside diameter of the conducting hole 3), a plurality of abrasive grains 5 may be fixed in each conducting hole 3 as described below.

(Effects)

The wire tool 100 configured as described above has the following effects.

Since the conducting holes 3 are spaced apart from each other on the same line, the abrasive grains 5 fixed in the conducting holes 3 are also spaced apart from each other. Therefore, chips (not shown) produced by a given abrasive grain 5 are not stuck between the given abrasive grain 5 and its adjacent abrasive grain 5, and are not pressed against a work material (wafer etc., not shown) by its adjacent abrasive grain 5.

Also, since chips and coolant are discharged in random directions (not specific directions) during cutting, it is possible to reduce the risk of wire breakage caused by twisting of the wire 1. In particular, when cutting is performed by reciprocation of the wire 1, the discharge of chips and coolant is facilitated because they are discharged in random directions. Thus, cutting efficiency and cut quality can be improved (e.g., roughness and deformation of the cut surface can be reduced).

The abrasive grains 5 are fixed in the conducting holes 3 having a predetermined area, and are not fixed in any locations other than the conducting holes 3. Thus, since it is possible to prevent fixation of an unnecessarily large number of abrasive grains, the use of raw materials (abrasive grains) and the cost of manufacture can be reduced.

The conducting holes 3 can be formed easily because of their circular shape. The gap (G) between conducting holes 3 is greater than one third of the radius R of the conducting holes (G>R/3). This facilitates discharge of the chips and coolant described above. Even if some abrasive grains 5 fall off the outer periphery of the wire 1, they do not adhere to adjacent abrasive grains 5. Therefore, the depth of cut and the cutting load are stabilized.

The conducting holes 3 can be easily formed because they are evenly spaced on a single helical curve.

Increasing the gap (G) between conducting holes 3 facilitates discharge of the chips and coolant. However, increasing the gap (G) or the pitch (P) decreases the number of abrasive grains (or the number of aggregates of abrasive grains) per unit area of the outer periphery of the wire 1 (i.e., decreases the grain ratio). The gap (G) and the pitch (P) are determined in accordance with the conditions of use of the wire tool 100. For example, the gap (G) is preferably less than or equal to about 30 times the radius R of the conducting holes.

(Variations of Arrangement of Conducting Holes)

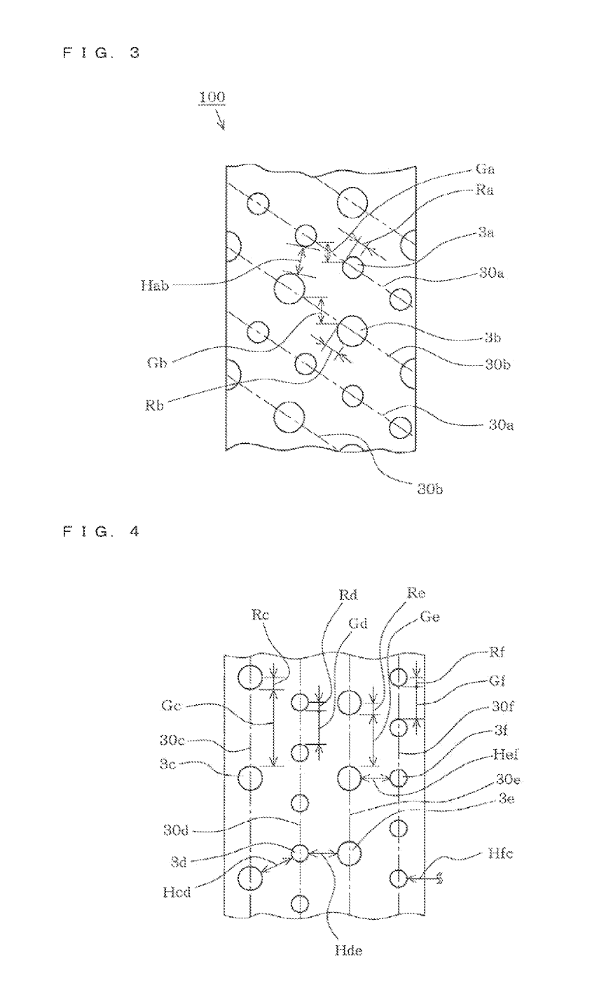

FIGS. 3 and 4 are each a developed plan view for explaining a variation of the arrangement of conducting holes. FIG. 3 illustrates conducting holes evenly spaced on multiple helical curves. FIG. 4 illustrates conducting holes evenly spaced on straight lines parallel to the axial direction, at a plurality of positions evenly spaced in the circumferential direction of the wire. Note that parts equal or corresponding to those illustrated in FIG. 1 are given the same reference numerals and the description thereof will be partially omitted. Each drawing is schematic and is not given for restrictive purposes. Note that relative sizes (thicknesses) are exaggerated in the drawings.

Referring to FIG. 3, the conducting holes 3 are evenly spaced on each of a first helical curve 30a and a second helical curve 30b having the same pitch in the outer periphery of the wire 1.

That is, conducting holes 3a having a radius Ra are arranged on the first helical curve 30a, with equal gaps (in the longitudinal direction, to be exact) Ga therebetween each being greater than one third of the radius Ra. Similarly, conducting holes 3b having a radius Rb are arranged on the second helical curve 30b, with equal gaps (in the longitudinal direction, to be exact) Gb therebetween each being greater than one third of the radius Rb (the term “conducting holes 3” collectively refers to both the conducting holes 3a and the conducting holes 3b). In the following description, the suffixes “a” and “b” of reference characters may be omitted to refer to common things.

A gap Hab between one of the conducting holes 3a on the first helical curve 30a and one of the conducting holes 3b on the second helical curve 30b closest to each other is greater than one third of both the radius Ra and the radius Rb (Hab>Ra/3, Hab>Rb/3).

Although the number of helical curves is two in this example, the present invention is not limited to this, and the number of helical curves may be three or more. The radius Ra and the radius Rb may be equal, and the gap Ga and the gap Gb may also be equal.

Referring to FIG. 4, the conducting holes 3 are equiangularly spaced (90 degrees apart) and arranged at four positions in the circumferential direction of the outer periphery of the wire 1. The conducting holes 3 are evenly spaced on straight lines 30c, 30d, 30e, and 30f parallel to the axial direction of the wire 1. In the following description, the suffixes “c”, “d”, “e”, and “f” of reference characters may be omitted to refer to common things.

Conducting holes 3c having a radius Rc are arranged on the straight line 30c, with equal gaps Gc therebetween each being greater than one third of the radius Rc. Similarly, conducting holes 3d, 3e, and 3fc having radii Rd, Re, and Rf are arranged on the straight lines 30d, 30e, and 30f, with equal gaps Gd, Ge, and Gf therebetween each being greater than one third of the respective radii Rd, Re, and Rf.

A gap Hcd between one of the conducting holes 3c on the straight line 30c and one of the conducting holes 3d on the straight line 30d closest to each other is greater than one third of both the radius Re and the radius Rd (Hcd>Rc/3, Hcd>Rd/3). A gap Hde between one of the conducting holes 3d on the straight line 30d and one of the conducting holes 3e on the straight line 30e closest to each other is greater than one third of both the radius Rd and the radius Re (Hde>Rd/3, Hde>Re/3). The same applies to the other gaps, which can be defined by “Hef>Re/3, Hef>Rf/3” and “Hfc>Rf/3, Hfc>Rc/3”.

Although four straight lines are equiangularly spaced in the circumferential direction in this example, the present invention is not limited to this, and the number of straight lines may be five or more. The radii Rc, Rd, and the like may be equal (this makes the gaps Ge, Gd, and the like equal). In this case, the conducting holes 3 arranged on straight lines can be regarded as being arranged on helical curves, such as those illustrated in FIG. 3 (conversely, conducting holes 3 arranged on helical curves may be regarded as being arranged on straight lines).

The conducting holes 3c, 3d, 3e, and 3f may be arranged in a grid pattern.

(Variations of Fixed State of Abrasive Grains)

FIGS. 5 to 8 illustrate variations of the fixed state of abrasive grains. In each of FIGS. 5 to 8, (a) is a developed plan view and (b) is a cross-sectional view of the developed plan view. Note that parts equal or corresponding to those illustrated in FIG. 1 are given the same reference numerals and the description thereof will be partially omitted. Although the abrasive grains having a spherical shape are shown in the drawings, the shape of the abrasive grains in the present invention is not limited to the spherical shape.

The conducting holes 3 illustrated in FIGS. 5 to 8 correspond to those obtained by changing the helical curves in FIG. 3, where the conducting holes 3 are arranged at the same positions in the axial direction, to three helical curves, or by making the radii Rc, Rd, and the like in FIG. 3 the same (or, to be exact, by arranging the conducting holes 3 and the like at the same positions in the axial direction at some of the locations).

The variations of the fixed state of abrasive grains are applicable not only to the configuration illustrated in FIG. 3, but also to configurations of Embodiments 2 to 5 (FIGS. 9 to 12) to be described.

(Single Grains)

Referring to FIG. 5, a single abrasive grain 5 is fixed in each conducting hole 3. The diameter of the abrasive grains 5 is smaller than that of the conducting holes 3 (e.g., 40% to 60% of the diameter of the conducting holes 3). That is, the diameter of abrasive grains mixed in the plating solution is smaller than the diameter of the conducting holes 3. Generally, the center of each abrasive grain 5 does not coincide with that of the corresponding conducting hole 3, and the amount and direction of deviation between them are indefinite.

(Combined Grains)

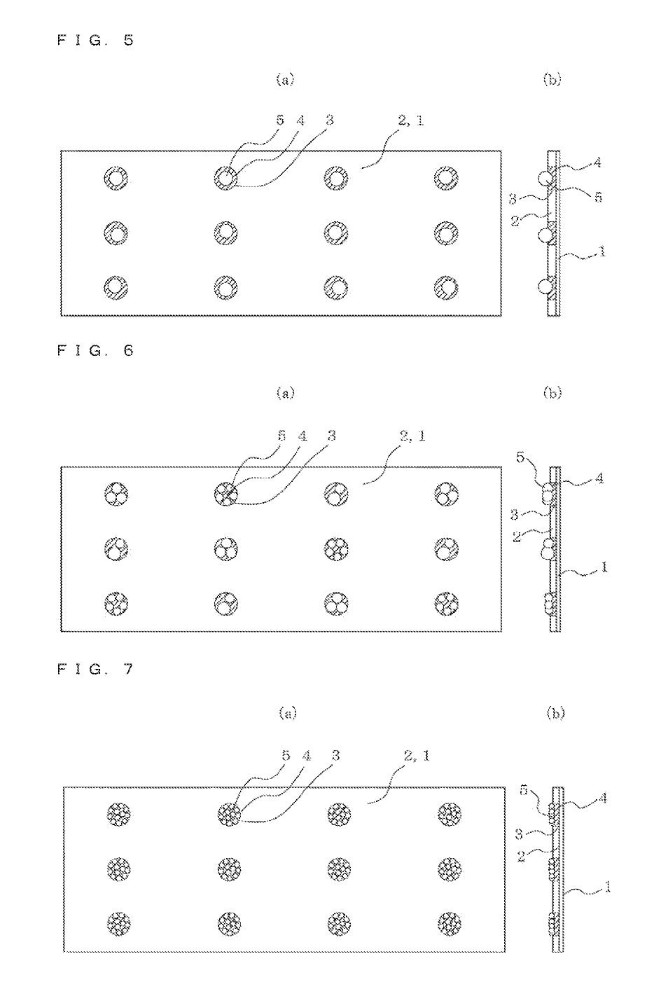

Referring to FIG. 6, several (about two to five) abrasive grains 5 are fixed in each conducting hole 3, and the abrasive grains 5 are in contact or bonded together by plating. The diameters of the abrasive grains 5 are smaller than about one half of that of the conducting holes 3 and greater than about one twelfth of that of the conducting holes 3.

That is, since the diameters of the abrasive grains mixed in the plating solution are configured to fall within the range described above, the number of fixed abrasive grains 5 and how they are bonded together are different for each conducting hole 3.

(Combined Fine Grains: Single Layer)

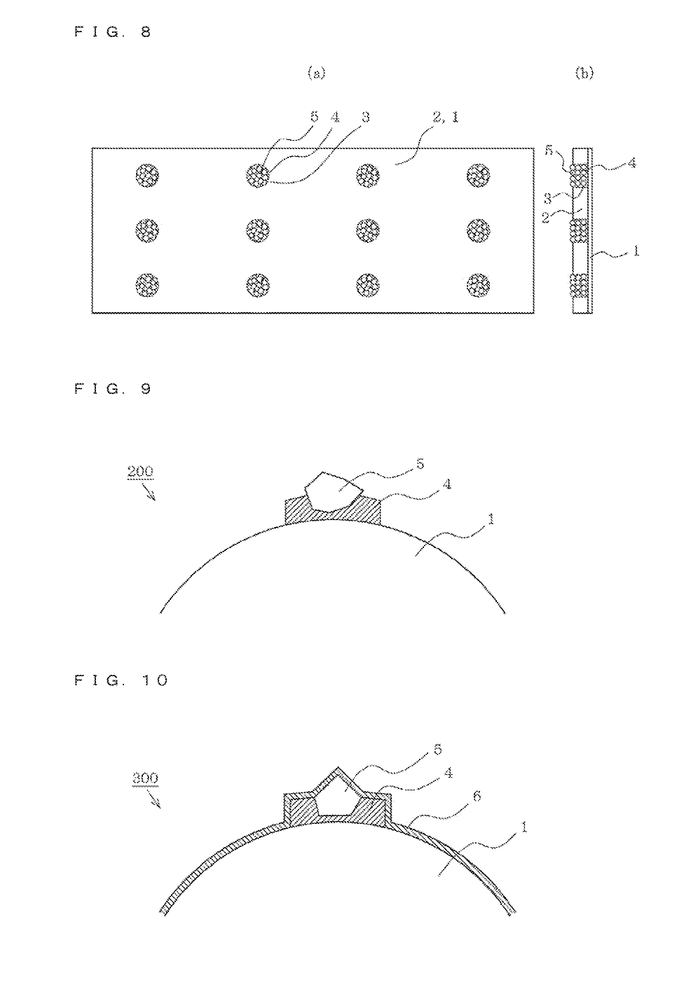

Referring to FIGS. 7 and 8, many (about ten or more) fine abrasive grains 5 (e.g., having a diameter less than or equal to one twelfth of that of the conducting holes 3) are arranged and fixed in substantially the same plane in each conducting hole 3, and the abrasive grains 5 are bonded to each other by plating. That is, the surfaces (tops) of the abrasive grains 5 fixed in the conducting hole 3 are located in substantially the same plane. Since fine abrasive grains are mixed into the plating solution for plating codeposition, the number of fixed abrasive grains 5 and how they are bonded together are different for each conducting hole 3.

(Combined Fine Grains: Aggregated and Fixed)

FIG. 8 illustrates fine abrasive grains 5 three-dimensionally aggregated and fixed in the conducting holes 3. That is, even when the abrasive grains 5 are “fine” grains with a diameter of, for example, 10 μm or less or, in particular, 5 μm or less, since the abrasive grains 5 are randomly fixed in the conducting holes 3 by plating codeposition, cutting edges spaced apart from each other can be provided. To clarify the difference with FIG. 7 (single layer), FIG. 8 schematically illustrates the abrasive grains 5 aggregated and fixed in layers. However, such layers are actually not clearly recognizable.

In FIG. 8, the insulating layer 2 is not limited to a particular thickness. By reducing the thickness of the insulating layer or by removing the insulating layer 2 as described below (see Embodiment 2), the fine abrasive grains 5 can form cutting edges with increased protrusions and thus can provide sharpness sufficient for cutting.

Fixing the combined fine grains as described above is effective for the abrasive grains 5 having an outside diameter of less than 20 μm and, in particular, less than or equal to 10 μm to which it is difficult to apply treatment (see Embodiment 5) that turns the surface of each abrasive grain into a conductive material.

As described above, the wire tool 100 can appropriately select a variation of the fixed state of abrasive grains.

Even when the abrasive grains 5 are fines grains, they are firmly fixed in a duster in each conducting hole 3. Therefore, it is possible to efficiently cut a wafer or the like at a stable level of quality while facilitating discharge of chips and coolant.

### Embodiment 2: Insulating Layer Removed Type

FIG. 9 is an enlarged front cross-sectional view illustrating an abrasive-grain wire tool according to Embodiment 2 of the present invention. Note that parts equal or corresponding to those of Embodiment 1 (FIG. 1 etc.) are given the same reference numerals and the description thereof will be partially omitted. The drawing is schematic, and Embodiment 2 is not limited to the illustrated configuration. Note that relative sizes (thicknesses) are exaggerated in the drawing.

An abrasive-grain wire too (hereinafter referred to as “wire tool”) 200 illustrated in FIG. 9 is obtained by removing the insulating layer 2 covering the outer periphery of the wire 1 of the wire tool 100 after the abrasive grains 5 are fixed. That is, the conducting holes 3 do not exist as “holes” and are replaced with the conducting hole plating 4.

Therefore, the wire tool 200 can provide the same effects as those of the wire tool 100. Also, by removing the insulating layer 2 as described above, the abrasive grains 5 can form cutting edges with increased protrusions and thus can provide sharpness sufficient for cutting.

The wire tool 200 can adopt each variation of the wire tool 100 described in Embodiment 1.

### Embodiment 3: Full-Surface Plating Type

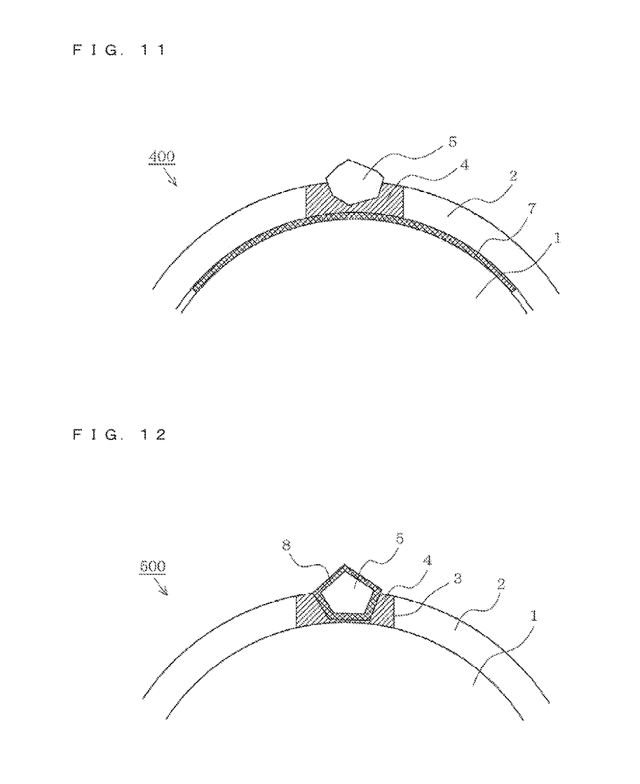

FIG. 10 is an enlarged front cross-sectional view illustrating an abrasive-grain wire tool according to Embodiment 3 of the present invention. Note that parts equal or corresponding to those of Embodiments 1 and 2 (FIG. 1 etc.) are given the same reference numerals and the description thereof will be partially omitted. The drawing is schematic, and Embodiment 3 is not limited to the illustrated configuration. Note that relative sizes (thicknesses) are exaggerated in the drawing.

An abrasive-grain wire tool (hereinafter referred to as “wire tool”) 300 illustrated in FIG. 10 is obtained by covering the exposed outer periphery of the wire 1 and the surfaces of the conducting hole plating 4 and the abrasive grains 5 in the wire tool 200 with plating (hereinafter referred to as “full-surface plating”) 6.

Since the exposed outer periphery of the wire 1 of the wire tool 200 is covered with the full-surface plating 6 which is hard, it is possible to improve wear resistance, reduce the risk of wire breakage, and improve cutting efficiency.

Since the full-surface plating 6 reinforces the fixation of the abrasive grains 5 with the conducting hole plating 4, the risk of falling of the abrasive grains 5 can be reduced.

The full-surface plating 6 may be produced by a composite plating solution mixed with one or more of the following types: fine abrasive grain, fine cerium oxide particle, and fine zircon sand. In this case, the full-surface plating 6 has the effect of improving wear resistance, resistance to adhesion of chips, or lapping characteristics, in cooperation with the abrasive grains 5, and the mixed fine abrasive grains or the like (codeposited with plating) contribute to the cutting of a wafer or the like. Therefore, it is possible to further improve cutting efficiency and cut quality (e.g., further reduce roughness and deformation of the cut surface).

### Embodiment 4: Wire Base Plating Type

FIG. 11 is an enlarged front cross-sectional view illustrating an abrasive-grain wire tool according to Embodiment 4 of the present invention. Note that parts equal or corresponding to those of Embodiment 1 (FIG. 1 etc.) are given the same reference numerals and the description thereof will be partially omitted. The drawing is schematic, and Embodiment 4 is not limited to the illustrated configuration. Note that relative sizes (thicknesses) are exaggerated in the drawing.

An abrasive-grain wire too hereinafter referred to as “wire tool”) 400 illustrated in FIG. 11 is obtained by covering the outer periphery of the wire 1 of the wire tool 100 with wire base plating 7 in advance. That is, since the insulating layer 2 is formed on the wire base plating 7 and the conducting holes 3 are formed in parts of the insulating layer 2, the wire base plating 7 is exposed to the bottom of each conducting hole 3.

The abrasive grains 5 are fixed by the conducting hole plating 4 adhering to the wire base plating 7. Thus, the abrasive grains 5 can be further firmly fixed, and the risk of falling of the abrasive grains 5 can be further reduced.

The wire 1 covered with the wire base plating 7 in advance can also be used in Embodiments 2 and 3 (where variations described in Embodiment 1 can be adopted).

### Embodiment 5: Abrasive Grain Conduction Treatment Type

FIG. 12 is an enlarged front cross-sectional view illustrating an abrasive-grain wire tool according to Embodiment 5 of the present invention. Note that parts equal or corresponding to those of Embodiment 1 (FIG. 1 etc.) are given the same reference numerals and the description thereof will be partially omitted. The drawing is schematic, and Embodiment 5 is not limited to the illustrated configuration. Note that relative sizes (thicknesses) are exaggerated in the drawing.

An abrasive-grain wire tool (hereinafter referred to as “wire tool”) 500 illustrated in FIG. 12 is obtained by pretreating the surfaces of the abrasive grains 5 of the wire tool 100 to turn them each into a conductive material 8.

Therefore, when the abrasive grains 5 are fixed in the conducting holes 3, the conducting hole plating 4 adheres to the conductive material 8 on the surface of each abrasive grain. This allows the abrasive grains 5 to be further firmly fixed, and further reduces the risk of falling of the abrasive grains 5.

The abrasive grains 5 each having the surface pretreated with the conductive material 8 can also be used in Embodiments 2 to 4 (where variations described in Embodiment 1 can be adopted).

### INDUSTRIAL APPLICABILITY

The present invention facilitates discharge of chips and coolant during cutting of a wafer or the like, improves the quality of the cut surface to allow production of high-quality wafers, increases the life of the tool, and improves the cutting efficiency to reduce the cutting cost. The present invention is applicable to various abrasive-grain wire tools capable of cutting various work materials,

### REFERENCE SIGNS LIST

1: wire, 2: insulating layer, 3: conducting hole, 4: conducting hole plating, 5: abrasive grain, 6: full plating, 7: wire base plating, 8: conductive material, 30: helical curve, 30a: helical curve, 30b: helical curve, 30c: straight line, 30d: straight line, 30e: straight line, 100: abrasive-grain wire tool (Embodiment 1), 200: abrasive-grain wire tool (Embodiment 2), 300: abrasive-grain wire tool (Embodiment 3), 400: abrasive-grain wire tool (Embodiment 4), 500: abrasive-grain wire tool (Embodiment 5), G: gap between abrasive grains, R: radius of conducting hole, H: gap between abrasive grains, P: pitch of helical curve, θ: inclination of helical curve

1. An abrasive-grain wire tool comprising:
a wire: and
a plurality Of abrasive grains fixed by conducting hole plating or abrasive grains aggregated and fixed by conducting hole plating, in conducting holes at multiple points in an insulating layer covering an outer periphery of the wire,
wherein the conducting holes are spaced apart from each other on a same line, with gaps therebetween.

2. The abrasive-grain wire tool of claim wherein the insulating layer is removed.

3. The abrasive-grain wire tool of claim 2, wherein surfaces of the abrasive grains, surfaces of the conducting hole plating, and the outer periphery of the wire except the surfaces of the abrasive grains and the surfaces of the conducting hole plating are covered with full-surface plating.

4. An abrasive-grain wire tool comprising:
a wire having an outer periphery covered with base plating; and
a plurality of abrasive grains fixed by conducting hole plating or abrasive grains aggregated and fixed by conducting hole plating, in conducting holes at multiple points in an insulating layer covering, a surface of the base plating on the wire,
wherein the conducting holes are spaced apart from each other on a same line, with gaps therebetween.

5. The abrasive-grain wire tool of claim 4, wherein the insulating layer is removed.

6. The abrasive-grain wire tool of claim 5, wherein surfaces of the abrasive grains, surfaces of the conducting hole plating, and the surface of the base plating on the wire except the surfaces of the abrasive grains and the surfaces of the conducting hole plating are covered with full-surface plating.

7. The abrasive-grain wire tool of claim 3, wherein the full-surface plating is composite plating mixed with one or more of the following types: fine abrasive grain, fine cerium oxide particle, and fine zircon sand.

8. The abrasive-grain wire tool of claim 1, wherein the gaps each between every two adjacent conducting holes are equal.

9. The abrasive-grain wire tool of claim 1, wherein the conducting holes have a circular shape, and the gaps between the conducting holes are each greater than one-third of a radius of the circular shape.

10. The abrasive-grain wire tool of claim 1, wherein the conducting holes are arranged on one or more helical curves in the outer periphery of the wire.

11. The abrasive-grain wire toot of claim 1, wherein the conducting holes are arranged on straight lines parallel to a longitudinal direction of the wire, and equiangularly spaced apart in a circumferential direction of the wire.

12. (canceled)

13. The abrasive-grain wire tool of claim 1, wherein before the abrasive grains are fixed in the conducting holes, outer peripheries of the abrasive grains are pretreated with a conductive material.

14. The abrasive-grain wire tool of claim 6, wherein the full-surface plating is composite plating mixed with one or more of the following types: fine abrasive grain, fine cerium oxide particle, and fine zircon sand.

15. The abrasive-grain wire tool of claim 4, wherein the gaps each between every two adjacent conducting holes are equal.

16. The abrasive-grain wire tool of claim 4, wherein the conducting holes have a circular shape, and the gaps between the conducting holes are each greater than one-third of a radius of the circular shape.

17. The abrasive-grain wire tool of claim 4, wherein the conducting holes are arranged on one or more helical curves in the outer periphery of the wire.

18. The abrasive-grain wire tool of claim 4, wherein the conducting holes are arranged on straight lines parallel to a longitudinal direction of the wire, and equiangularly spaced apart in a circumferential direction of the wire.

19. The abrasive-grain wire tool of claim 4, wherein before the abrasive grains are fixed in the conducting holes, outer peripheries of the abrasive grains are pretreated with a conductive material
